(19) United States
(12) Patent Application Publication
(10) Pub. No.: US 2025/0339241 A1
(43) Pub. Date: Nov. 6, 2025

(54) MISCIBLE POLYESTER BLENDS SUITABLE FOR DENTAL APPLIANCES AND METHODS FOR FORMING THE SAME

(71) Applicant: 3M INNOVATIVE PROPERTIES COMPANY, Saint Paul, MN (US)

(72) Inventors: Ta-Hua YU, Woodbury, MN (US); Stephen A. JOHNSON, Woodbury, MN (US); Timothy J. HEBRINK, Scandia, MN (US); Bruce R. BROYLES, Oakdale, MN (US); Pamela A. PERCHA, Woodbury, MN (US); Li YU, Santa Clara, CA (US); Michael R. BERRIGAN, Oakdale, MN (US); Junkang J. LIU, Woodbury, MN (US); Troy J. ANDERSON, Afton, MN (US)

(21) Appl. No.: 18/855,545

(22) PCT Filed: Mar. 24, 2023
(86) PCT No.: PCT/IB2023/052933

§ 371 Date: Oct. 9, 2024

Related U.S. Application Data
(60) Provisional application No. 63/330,453, filed on Apr. 13, 2022.

(51) Int. Cl. A61C 7/08; B29C 51/00; B29K 67/00; B29K 105/00; B29L 31/00; C08L 67/02

(52) U.S. Cl. CPC A61C 7/08; B29C 51/002; C08L 67/025; B29K 2067/00; B29K 2105/0088; B29K 2995/0026; B29L 2031/753; C08L 2203/30; C08L 2205/025

(57) ABSTRACT

The present disclosure is directed to polyester blends featuring an amorphous first polyester and a second, semi-crystalline polyester elastomer. The first and second polyesters are miscible, in that the first and second polyesters form a homogenous, single-phase blend. The homogenous blend will exhibit a transparent melt and a single glass transition temperature. When used to form a sheet or film, the polyester blends demonstrate a low haze and enhanced force persistence.

### BACKGROUND

Orthodontic treatments involve repositioning misaligned teeth and improving bite configurations for improved cosmetic appearance and dental function. Repositioning teeth is accomplished by applying controlled forces to the teeth of a patient over an extended treatment time period.

Teeth may be repositioned by placing a dental appliance such as a polymeric incremental position adjustment appliance, generally referred to as an orthodontic aligner or an orthodontic aligner tray, over the teeth of the patient. The orthodontic alignment tray includes a polymeric shell with a plurality of cavities configured for receiving one or more teeth of the patient. The individual cavities in the polymeric shell are shaped to exert force on one or more teeth to resiliently and incrementally reposition selected teeth or groups of teeth in the upper or lower jaw. A series of orthodontic aligner trays are provided for wear by a patient sequentially during each stage of the orthodontic treatment to gradually reposition teeth from misaligned tooth arrangement to a successive more aligned tooth arrangement until a desired tooth alignment condition is ultimately achieved. Once the desired alignment condition is achieved, an aligner tray, or a series of aligner trays, may be used periodically or continuously in the mouth of the patient to maintain tooth alignment. In addition, orthodontic retainer trays may be used for an extended time period to maintain tooth alignment following the initial orthodontic treatment.

A stage of an orthodontic treatment may require that a polymeric orthodontic retainer or aligner tray remain in the mouth of the patient for up to 22 hours a day, over an extended treatment time period of days, weeks or even months.

Polyesters and copolyesters have been suggested for use in both single layer and multilayer films that find utility in dental and orthodontic applications. Such films may include certain layers of polyester or copolyester amongst other polymeric materials or may consist essentially of polyester or copolyester. An orthodontic alignment tray, for example, made primarily from a relatively stiff polyester can effectively exert a stable and consistent repositioning force against the teeth of a patient but can cause discomfort when the dental appliance repeatedly contacts oral tissues or the tongue of a patient over an extended treatment time. These high modulus polyesters can also have poor stress retention behavior in hydrated state when used in an oral or other aqueous environment.

There remains a need for improved materials suitable to form single layer and multilayer films that find utility in dental and orthodontic applications.

### SUMMARY

Polymer blends are mixtures of structurally different polymers or copolymers. Most polymer-blend pairs form immiscible two-phase structures that are often hazy or opaque and which have properties that are inferior to those that would be predicted from combining the polymer components. Miscible polymer blends, by contrast, can provide properties that are proportional to the relative amounts of the component polymers. Miscible polymer blends, especially in the absence of so-called compatibilizers, are relatively rare.

The present disclosure is directed to polyester blends featuring an amorphous first polyester and a second, semi-crystalline polyester elastomer. The first and second polyesters are miscible, in that the first and second polyesters form a homogenous, single-phase blend. The homogenous blend will exhibit transparency and a single glass transition temperature. The single glass transition temperature exhibited by the blend will depend on the relative amounts of first and second polyesters in the blend. When used to form a sheet or film, the polyester blends demonstrate a low haze and enhanced force persistence. Such properties may be particularly advantageous for use in dental appliances.

The new miscible polyester blends can deliver a broad range of properties from transparent elastomer-like materials, highly crystalline materials to transparent glassy materials with tunable mechanical, optical and thermal properties. The polyester blends can find utility in multilayer optical films, conductive & insulation films, safety & security films, display films, commercial graphics, fabrics for wound care and substrates for release liners.

The present disclosure is further directed to a method for extruding a polyester blend including an amorphous first polyester and a second, semi-crystalline polyester elastomer. The blend may be subject to lower extruder or calendar throughput rates than typical, increasing the time the blend resides within the extruder. The increase in residence time can, surprisingly, lead to advantageous optical properties despite relatively higher crystallization in the pre-extruded polyester blend.

In another aspect, the present disclosure is directed to orthodontic dental appliances configured to move or retain the position of teeth in an upper or lower jaw of a patient such as, for example, an orthodontic aligner tray or a retainer tray. High modulus polymeric materials, such a polyester and copolyester, can have poor stress retention behavior in hydrated state when used in an oral or other aqueous environment to provide an adequate level of force persistence. Force persistence can be considered in tandem with stress relaxation, with the persistence an inverse of relaxation and defined as 100% minus % stress relaxation (e.g., a stress relaxation of 25% equates to a force persistence of 75%). A rubberier elastomer, such as certain copolyester ethers, can have better stress retention behavior, but in many cases may be too soft to be used alone in a dental appliance to effectively move teeth into a desired alignment condition in a reasonably short treatment time.

In addition, the warm and moist environment in the mouth can cause the polymeric materials in the dental appliance to absorb moisture and swell, which can compromise the mechanical tooth-repositioning properties of the dental appliance. These compromised mechanical properties can reduce tooth repositioning efficiency and undesirably extend the treatment time required to achieve a desired tooth alignment condition. Further, in some cases repeated contact of the exposed surfaces of the dental appliance against the teeth of the patient can prematurely abrade the exposed surfaces of the dental appliance and cause discomfort.

The present disclosure is accordingly directed to dental appliances such as, for example, an orthodontic aligner tray or retainer tray, that include at least one layer of a miscible, polyester blend to improve optical properties while maintaining an acceptable level of force persistence. The polyester blend and other polymers in the dental appliance can be selected to provide other beneficial properties such as, for example, good stain resistance, and good mold release properties after the dental appliance is thermally formed from a multilayered polymeric film.

The present disclosure also relates to thermoforming processes that tend to balance force persistence and other advantageous mechanical properties with low haze and high light transmission. The term “thermoforming” refers to a process for preparing a shaped, formed, etc., article from a thermoformable film or web of polymeric material. In typical thermoforming, the thermoformable web may be heated to its melting or softening point, stretched over or into a temperature-controlled, single-surface mold and then held against the mold surface until cooled (solidified). The formed article may then be trimmed to remove excess thermoformed material. Thermoforming may include vacuum molding, pressure molding, plug-assist molding, vacuum snapback molding, etc.

In some embodiments, the multilayered dental appliance is transparent or translucent, and has enhanced crack resistance and force persistence, good staining resistance, improved patient comfort and improved dimensional stability.

In one aspect, the present disclosure provides a film with a least one layer including a polyester blend. The blend itself comprises: a first, amorphous polyester; and a second, semi-crystalline polyester elastomer, wherein the polyester blend does not include a substantial amount of plasticizer, and wherein the film has a haze of no greater than 20%, determined using ASTM D1003-13.

In one aspect, the present disclosure provides a dental appliance comprising a polymeric shell comprising a plurality of cavities for receiving one or more teeth. The polymeric shell comprises at least one layer including a polyester blend. The blend itself comprises: a first, amorphous polyester; and a second, semi-crystalline polyester elastomer, wherein the polyester blend does not include an effective amount of plasticizer, and wherein the shell has an Expected haze of no greater than 20%, determined using ASTM D1003-13.

In another aspect, the present disclosure provides a method of forming a shaped article, the method comprising: providing a sheet of film comprising at least one layer including a polyester blend. The blend comprises (a) a first, amorphous polyester; and (b) a second, semi-crystalline polyester elastomer, wherein the polyester blend does not include a substantial amount of plasticizer. The method further includes the steps of providing a first positive model, drawing the sheet over the model at a molding temperature, and cooling the sheet and model to atmospheric temperature to form an article.

The term “polyester”, as used herein, includes “copolyesters” and means a synthetic polymer prepared by the polycondensation of one or more difunctional carboxylic acids with one or more difunctional hydroxyl compounds.

The term “polyester elastomer”, as used herein, means a polyester having a modulus of about 1 to 500 megapascals (MPa) (at room temperature).

The term “residue”, as used herein, means any organic structure incorporated into a polymer or plasticizer through a polycondensation reaction involving the corresponding monomer.

The term “dicarboxylic acid”, as used herein, means dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

As used herein, “dental appliance” means any device capable of influencing the position, orientation, or composition of the teeth, including by way of example only, aligners, positioners, night guards, retainers, splints, bleaching trays, and anterior bridges.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF DRAWINGS

FIG. 1 is a schematic overhead perspective view of an embodiment of a dental appliance;

FIG. 2 is a schematic, cross-sectional view of an embodiment of a multilayered dental appliance of FIG. 1;

FIG. 3 is a schematic overhead perspective view of a method for using an orthodontic alignment tray by placing the dental alignment tray on a dental arch;

FIG. 4A is a schematic overhead perspective view of a planar arch model and thermoformed tray used in testing Haze of shaped articles;

FIG. 4B is a perspective view of the thermoformed tray of FIG. 4A, looking towards the interior surfaces.

FIG. 5 depicts the cooling signal from Differential Scanning calorimetry (DSC) results for the polymer blends films from Example 1, Example 2, and Comparative Example 1, cooling at 10° C./min; and

FIG. 6 depicts the heat flow signal from Differential Scanning calorimetry (DSC) results for the polymer blends films from Example 1, Example 2, and Comparative Example 1, heating post cooling at 10° C./min.

Like symbols in the drawings indicate like elements. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the embodiments described herein.

### DETAILED DESCRIPTION

The polyester blends of the present disclosure comprise at least one first amorphous polyester and at least one, different, second polyester elastomer. The term “polyester blend,” as used herein, means a physical blend of at least 2 different polyesters. Typically, polyester blends are formed by blending the polyester components in the melt phase. The polyester blends of the present disclosure are miscible or homogeneous blends. The term “miscible,” as used herein, is synonymous with the term “homogeneous blend,” and means that the blend has a single, homogeneous phase as indicated by a single, composition-dependent glass transition temperature (abbreviated herein as “Tg”) as determined by either standard differential scanning calorimetry or modulated differential scanning calorimetry (DSC and/or MDSC™). Suitable first and second polyester individually possess sufficiently different glass transition temperatures such that the presence of a single Tg in the blend is a reasonable proxy for miscibility. The Tg of the miscible blend is a value between the Tg of the first polyester and second polyester. Polyester blends may be synthesized via condensation polymerization, melt polymerization, solid-state polymerization, or combinations thereof.

The polyesters used in the blend may be prepared by conventional polycondensation procedures well-known in the art. Such processes include direct condensation of the dicarboxylic acid(s) with the diol(s) or by ester interchange using a dialkyl dicarboxylate.

In some embodiments, the polyester blend is a binary blend, in that it contains no more than two polyester components (i.e., the first amorphous polyester and the second, elastomeric polyester). In other embodiments, the polyester blend may be a ternary blend including the first polyester, second polyester, and a compatibilizer. As used herein, a “compatibilizer” is a functional, non-reactive polymer added to a polymer blend to improve the interfacial adhesion between components of the blend. Commonly used compatibilizers are block, graft, or random copolymers consisting of dissimilar blocks. The compatibilizer may also be a polyester, but this is not strictly necessary. The present inventors have surprisingly discovered binary blends of copolyesters that are miscible even in the absence of a compatibilizer.

The first polyester (A) of the polyester blend comprises a co-polyester comprising terephthalic acid and/or isophthalic acid, cyclohexane dimethanol, and 2,2,4,4-tetramethyl-1,3-cyclobutanediol. Such a copolyester can include a dicarboxylic acid component comprising 70 mole % to 100 mole % of terephthalic acid residues, and a diol component comprising, (i) 0 to 95% ethylene glycol, (ii) 5 mole % to 50 mole % of 2,2,4,4-tetramethyl-1,3-cyclobutanediol residues, and (ii) 50 mole % to 95 mole % 1,4-cyclohexanedimethanol residues, and (iii) 0 to 1% of a polyol having three or more hydroxyl groups, wherein the sum of the mole % of diol residues (i) and (ii) and (iii) amounts to 100 mole % and the copolyester exhibits a glass transition temperature Tg from 80° C. to 150° C. A suitable copolyester for use as the first polyester is 2,2,4,4-tetramethyl-1,3-cyclobutanediol modified poly(1,4-cyclohexylenedimethylene terephthalate) (PCTT) as further explored in U.S. Pat. No. 9,2373,206 (Neill et al.), and is commercially available under the TRITAN brand from Eastman Chemical, Kingsport, TN.

The first polyester (A) can also comprise 0 to 10 mole %, for example, from 0.01 to 5 mole % based on the total mole percentages of either the diol or diacid residuals, respectively, of one or more residues of a branching monomer, also referred to as a branching agent, having 3 or more carboxyl substituents, hydroxyl substituents, or a combination therefor. In certain embodiments, the branching agent may be added prior to and/or during and/or after the polymerization of the polyester.

Suitable polyesters for use as the first, amorphous polyester generally have a glass transition temperature (Tg) as determined by either DSC or MDSC™ ranging from about 100° C. to 125° C.

The first polyester (A) is typically present in the blend at no greater than 70% weight, based on the total weight of the blend. In other embodiments, the first polyester is present in the blend at no greater than 65% weight, no greater than 60% weight, no greater than 55% by weight, no greater than 50% weight, based on the total weight of the blend. In the same or other embodiments, the first polyester is present in the blend at least 5% weight, at least 10% weight, at least 20% weight, at least 30% weight, and at least 40% weight, based on the total weight of the polyesters in the blend. In blends for use in typical dental applications, the range of first polyester in the blend is about 10 to 60% weight, based on the total weight of the blend. Blends below the bottom end of the range may demonstrate insufficient toughness or force persistence for oral use, while blends above the high end may demonstrate suboptimal optical properties (e.g., excess haze).

The polyester blend also comprises a second polyester (B), which is typically a semi-crystalline elastomer. Semi-crystalline polyesters can be distinguished from purely amorphous polymers in that they are composed of both crystalline and amorphous phases. Representative examples of polyester elastomers include, but are not limited to, random or block poly(ether ester) polymers comprising polyester segments and polyether segments having molecular weights of 400 to 12,000, and aromatic-aliphatic polyesters. In some embodiments, the polyester elastomer comprises (i) diacid residues comprising the residues of one or more diacids selected from the group consisting of substituted or unsubstituted, linear or branched aliphatic dicarboxylic acids containing 2 to 20 carbon atoms, substituted or unsubstituted, linear or branched cycloaliphatic dicarboxylic acids containing 5 to 20 carbon atoms, and substituted or unsubstituted aromatic dicarboxylic acids containing 6 to 20 carbon atoms; and (ii) diol residues comprising the residues of one or more substituted or unsubstituted, linear or branched, diols selected from the group consisting of aliphatic diols containing 2 to 20 carbon atoms, poly(oxyalkylene)-glycols and copoly(oxyalkylene)glycols of molecular weight of about 400 to about 12000, cycloaliphatic diols containing 5 to 20 carbon atoms, and aromatic diols containing 6 to 20 carbon atoms.

In some embodiments, the second, elastomeric polyester is chosen from copolyester ether elastomers, which may be linear, branched, or cyclic. Suitable copolyester ethers include poly(1,4-cyclohexanedimethylene 1,4-cyclohexanedicarboxylate) (PCCE), as well as PCCE modified with polytetramethylene ether glycol, as further explored in U.S. Pat. No. 8,071,695 (Strand et al.) and U.S. Pat. No. 4,349,469 (Davis et al.) Suitable copolyester ethers include materials available under the trade designation NEOSTAR and ECDEL, each from Eastman Chemical.

Suitable polyesters for use as the second, elastomeric polyester generally have a glass transition temperature (Tg) as determined by either DSC or MDSC™, ranging from about −50° C. to 20° C.

The second, elastomeric polyester is typically present in the blend at no greater than 95% weight, based on the total weight of polyesters in the blend. In other embodiments, the second polyester is present in the blend at no greater than 90% weight, no greater than 85% weight, no greater than 80% by weight, no greater than 70% weight, no greater than 65% weight, no greater than 60% weight, based on the total weight of the blend. In the same or other embodiments, the second polyester is present in the blend at least 35% weight, at least 40% weight, at least 45% weight, and at least 50% weight, based on the total weight of the polyesters in the blend. In blends for use in typical dental applications, the range of second polyester in the blend is about 40 to 70% weight, based on the total weight of the polyester in the blend.

The polyester blend preferably comprises about 5 to about 70% weight first amorphous polyester and about 95 to about 40% weight polyester elastomer. Other representative examples of blends include 5% weight first polyester, 95% weight second polyester elastomer; 10% weight first polyester, 90% weight polyester elastomer; 20% weight polyester, 80% weight polyester elastomer; 30% weight polyester, 70% weight polyester elastomer; 40% weight polyester, 60% weight polyester elastomer; 50% weight polyester, 50% weight polyester elastomer; 60% weight polyester, 40% weight polyester elastomer; 70% weight polyester, 30% weight polyester elastomer; 80% weight polyester, 20% weight polyester elastomer; 90% weight polyester, 10% weight polyester elastomer; and 95% weight polyester, 5% weight polyester elastomer.

The polyester blends may further comprise one or more additives in amounts that do not adversely affect the resulting blend properties such as haze (such as nucleating agents). Titanium dioxide and other pigments or dyes, may be included, for example, to control color of films produced from the blend, or to aid in marking for identification (e.g., laser marking).

The blends of the present disclosure can be prepared by any convenient process for example, by bringing the components in solid form and dry-blending using conventional means such as a barrel mixer, a tumble mixer, and the like, followed by fluxing or melting in an appropriate apparatus, such as a Banbury type internal mixer, Brabender mixers, roll mills, single or twin screw extruder or compounder, or the like. The two components may be brought together and processed in an appropriate melt extruder, from which the blend is extruded in the form of strands which are pelletized for fabrication purposes. Techniques well known to those skilled in the art can be used for these purposes.

The polyester blends of this disclosure are useful in creating shaped articles for multiple applications. The shaped article can be produced by any method known in the art including, but not limited to, extrusion, calendering, thermoforming, blow-molding, extrusion blow-molding, injection stretch blow-molding, injection molding, injection blow-molding, compression molding, profile extrusion, cast extrusion, melt-spinning, drafting, tentering, or blowing. The shaped articles can have a single layer or contain multiple layers. In some embodiments, the films, sheets, and injection molded articles and parts can be made using any extrusion process including extrusion processes whereby pellets are either blended together (when using concentrated ingredients) or added directly to an extruder (when using a fully compounded composition).

Producing a film or sheet using the polyester blends of the present disclosure can be accomplished several ways, for example, the first polyester and the second polyester can be compounded and then added to the throat of a single or twin-screw extruder. The compounded mixture in some embodiments is conveyed and compressed by the screw(s) down the extruder barrel to melt the mixture and discharge the melt from the end of the extruder. The end of the extruder may be equipped with a vacuum port to remove volatile compounds. The melt can then be fed through a die to create a continuous flat sheet or into a profile die to create a continuous shape. In the embodiments using the flat sheet die, the melt is extruded onto a series of metal rolls, typically three, to cool the melt and impart a finish onto the sheet. The flat sheet is then conveyed in a continuous sheet to cool the sheet. It can then be trimmed to the desired width and then either rolled up into a roll or sheared or sawed into sheet form. The presently preferred processing conditions for extruding a film can be found in the Examples below.

The polyester blends of the present disclosure may be calendered or extruded to produce a film or sheet having excellent optical properties, toughness, force persistence, and flexibility.

In various embodiments, a film or sheet formed from the polyester blend is substantially optically clear. The light transmission can be determined by ASTM D1003-13 using CIE illuminate C and the haze can also be determined using ASTM D1003-13 using CIE illuminate C. Some embodiments have a light transmission of at least about 50%. Some embodiments have a light transmission of at least about 75%. Some embodiments have a haze of no greater than 20 or no greater than 15%. Some embodiments have an Expected haze of no greater than 10%. Some embodiments have a haze of no greater than 5%. Some embodiments have a haze of no greater than 2.5%. The haze of the film or sheet of certain presently preferred embodiments is less than 10% and the light transmission of dental appliance is greater than 80%.

The present inventors discovered that the low haze films and/or sheets are possible to create using the polyester blends of the present disclosure in the absence of a substantial amount of plasticizer in the blend. Plasticizers, particularly when used in the oral environment, are likely to leach out of the shaped article and cause allergic and/or other potential adverse reactions for a patient, leading to a host of regulatory problems for a medical device manufacturer. As used herein, a substantial amount of plasticizer means greater than 5% by weight, based on the total weight of the blend. In other words, the blends of the present disclosure includes less than 5% by weight plasticizer. In additional or alternative implementations, the polyester blends of the present disclosure includes less than 4% by weight plasticizer, less than 3% by weight plasticizer, less than 2% by weight plasticizer, less than 1% by weight plasticizer, less than 0.5% by weight plasticizer, based on the total weight of the blend. In presently preferred implementations, the blend does not include any plasticizer.

Plasticizers are typically added to polyester and other polymer blends to enhance flexibility and mechanical properties of a calendered film or sheet. For polyester blends, the plasticizer typically comprises one or more aromatic rings and are soluble in at least the amorphous polyester. A plasticizer can also aid in lowering the processing temperature of a polyester. Examples of plasticizers include esters comprising (i) acid residues comprising one or more residues of: phthalic acid, adipic acid, trimellitic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms. Further non-limiting examples of alcohol residues of the plasticizer include methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol. A plasticizer also may comprise one or more benzoates, phthalates, phosphates, or isophthalates. In another example, the plasticizer comprises diethylene glycol dibenzoate.

The present inventors surprisingly found that increasing the residence time of the polyester blends within an extruder to greater than 7 minutes produces films and other shaped articles having a haze less than 20%, with no plasticizers present in the blend. In presently preferred conditions, the residence time is at least 8 minutes, which can result in film and other shaped articles having a haze less than 15%, and in some embodiments less than 10%, or less than 5%. Residence time can be considered inverse to throughput rates in an extruder, with higher throughput resulting in shorter residence time. The residence time vs. throughput can be determined by feeding colored pellets (e.g., blue dye) in the extruder and counting the time needed to observe the chosen color at the egress.

Residence time serves as a proxy for improved mixing of the first and second polyesters. Improved mixing may also be accomplished by alternative processing equipment that can disrupt laminar flow, e.g., extruder screw design, use of a planetary extruder, filter housing, active or static mixing, etc.

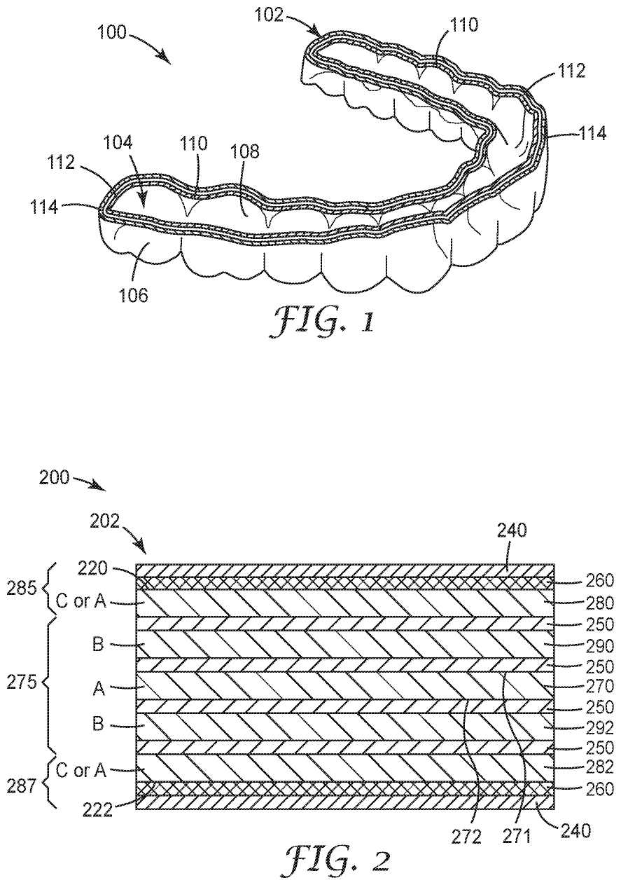

The polyester blends of the present disclosure are particularly well suited for creating dental appliances. One such dental appliance 100 is shown in FIG. 1, which is also referred to herein as an orthodontic aligner tray, includes a thin polymeric shell 102 having a plurality of cavities 104 shaped to receive one or more teeth in the upper or lower jaw of a patient. In some embodiments, in an orthodontic aligner tray the cavities 104 are shaped and configured to apply force to the teeth of the patient to resiliently reposition one or more teeth from one tooth arrangement to a successive tooth arrangement. In the case of a retainer tray, the cavities 104 are shaped and configured to receive and maintain the position of one or more teeth that have previously been aligned.

The shell 102 of the orthodontic appliance 100 is an arrangement of one or more layers of elastic polymeric materials that generally conforms to a patient's teeth, and may be transparent, translucent, or opaque. The polymeric materials can include at least one semi-crystalline polymer, typically an elastomer and are selected to provide maintain a sufficient and substantially constant stress profile during a desired treatment time, and to provide a relatively constant tooth repositioning force over the treatment time to maintain or improve the tooth repositioning efficiency of the shell 102. The shell may include a single layer including a polyester blend of the present disclosure or multiple layers, at least one of which includes a polyester blend of the present disclosure.

As depicted in FIG. 1, the shell includes an external surface 106. The external surface 106 contacts the tongue and cheeks of a patient. The shell 102 further includes an internal surface 108 that contacts the teeth of a patient. In single layer embodiments (or embodiments comprised of the same polymeric material stacked in a plurality layers), both the internal and external surface can be formed from a polyester blend of the present disclosure

A multilayer embodiment of the tray of FIG. 1 includes an arrangement of one or more polymeric layers 114, which also may be referred to herein as skin layers, forms an external surface 106 of the shell 102. The external surface 106 contacts the tongue and cheeks of a patient. An arrangement of one or more polymeric layers 110, which may also be referred to herein as skin layers, forms an internal surface 108 of the shell 102. The internal surface 108 contacts the teeth of a patient. An arrangement of one or more internal polymeric layers 112 resides between the polymeric layers 110 and 112. The thermoplastic polymeric materials in the layers 110, 112, 114 can be arranged to alternate such as, for example, in the arrangement ABA or BAB. For example, in the embodiment of FIG. 1, the layer 110 can include polymer A, the layer 114 can include polymer B, and the layer 112 can include polymer A. Or, the layer 110 can include polymer B, the layer 114 can include polymer A, and the layer 112 can include polymer B. Either or both of the polymer layers A and B may include the polyester blends of the present disclosure.

In some embodiments, the polymeric shell 102 has an overall flexural modulus necessary to move the teeth of a patient. In some embodiments, the polymeric shell 102 has an overall flexural modulus of greater than about 0.5 GPa, or about 0.8 GPa to about 1.5 GPa, or about 1.0 GPa to about 1.3 GPa.

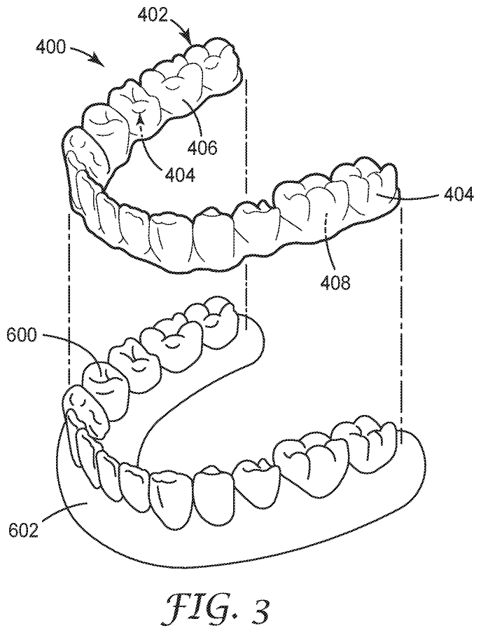

A schematic cross-sectional view of an embodiment of a dental appliance 200 is shown in FIG. 2, which includes a polymeric shell 202 with a multilayered polymeric structure. The polymeric shell 202 includes at least 3, or at least 5, or at least 7, alternating layers of thermoplastic polymers AB. The polymeric shell 202 includes an interior region 275 including a core layer 270 with a first major surface 271 and a second major surface 272. The interior region 275 further includes interior layers 290, 292 arranged on the first major surface 271 and the second major surface 272, respectively, of the core layer 270. The polymeric shell further includes exterior regions 285, 287 on opposed sides of the interior region 275. The exterior regions, which may also be referred to herein as skin layers, include first and second external surface layers 280, 282, which face outwardly on the exposed surfaces of the polymeric shell 202.

In some embodiments, the interfacial adhesion between any of the adjacent layers in the polymeric shell 202 is greater than about 150 grams per inch (6 grams per mm), or greater than about 500 grams per inch (20 grams per mm).

In the embodiment of FIG. 2, the core layer 270 includes one or more layers of a thermoplastic polymer A with a thermal transition temperature of about 70° C. to about 140° C., or about 80° C. to about 120° C., and a flexural modulus greater than about 1.3 GPa, or greater than about 1.5 GPa, or greater than about 2 GPa. In some embodiments, the thermoplastic polymer A has an elongation at break of greater than about 100%. As used in the present disclosure, a thermal transition temperature is any one of glass transition (Tg), melting temperature (Tm), and Vicat softening temperature. Methods for determining these values are set out in the Examples below.

For example, the thermoplastic polymer A may include a polyester or a copolyester, which may include linear, branched or cyclic segments on the polymer backbone. Suitable polyesters and copolyesters may include ethylene glycol on the polymer backbone or be free of ethylene glycol. Suitable polyesters include, but are not limited to, copolyesters with no ethylene glycol available under the trade designation TRITAN from Eastman Chemical, Kingsport, TN, polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate (PCTA), polycarbonate (PC), and mixtures and combinations thereof. Suitable PETg resins, which contain no ethylene glycol on the polymer backbone, can be obtained from various commercial suppliers such as, for example, Eastman Chemical, Kingsport, TN; SK Chemicals, Irvine, CA; DowDuPont, Midland, MI; Pacur, Oshkosh, WI; and Scheu Dental Tech, Iserlohn, Germany. For example, EASTAR GN071 PETg resins and PCTg VM318 resins from Eastman Chemical have been found to be suitable.

In one embodiment, the first and second external surface layers 280, 282, which may be the same or different, each include one or more layers of the thermoplastic polymer A utilized in the core layer 270.

In another embodiment, the first and the second external surface layers 280, 282 may include at one or more layers of a thermoplastic polymer C, different from the thermoplastic polymer A, wherein the thermoplastic polymer C has a thermal transition temperature of about 70° C. to about 140° C., or about 80° C. to about 120° C., and a flexural modulus greater than about 1.3 GPa, or greater than about 1.5 GPa, or greater than about 2 GPa. In some embodiments, the thermoplastic polymer C has an elongation at break of greater than about 100% or even greater than 150%. In some embodiments, a thermoformable polymeric sheet, is comprised of at least two outer layers A and C, and a middle layer B, wherein the A and C layers individually include a thermoplastic polymer.

For example, in some embodiments the thermoplastic polymer C may include a polyester or a copolyester, which may be linear, branched, or cyclic. Suitable polyesters include, but are not limited to, copolyesters available under the trade designation TRITAN from Eastman Chemical, Kingsport, TN, polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate (PCTA), polycarbonate (PC), and mixtures and combinations thereof. Suitable PETg and PCTg resins can be obtained from various commercial suppliers such as, for example, Eastman Chemical, Kingsport, TN; SK Chemicals, Irvine, CA; DowDuPont, Midland, MI; Pacur, Oshkosh, WI; and Scheu Dental Tech, Iserlohn, Germany. For example, EASTAR GN071 PETg resins and PCTg VM318 resins from Eastman Chemical have been found to be suitable.

The interior layers 290, 292, which may be the same or different, each include one or more layers of a thermoplastic polymer B, different from the thermoplastic polymer A, wherein the thermoplastic polymer B has a glass transition temperature of less than about 0° C., a vicat softening temperature of greater than 65° C., or greater than about 100° C., inherent viscosity greater than 1 cc/gm, and a flexural modulus less than about 1 GPa, or less than about 0.8 GPa, or less than about 0.25 GPa, or less than 0.1 GPa (i.e., typically having a modulus alone insufficient to move teeth absent the presence of layer(s) A and/or C). In some embodiments, the thermoplastic polymers B have a melting temperature of greater than about 70° C., or greater than about 100° C., greater than about 150° C., or greater than about 200° C. In some embodiments, the thermoplastic polymers B have an elongation at break of greater than about 300%, or greater than about 400%. In some embodiments, the ratio of elongation at break of polymers B to either of polymers A and C is no greater than about 5, or no greater than about 3.

In various embodiments, which are not intended to be limiting, the thermoplastic polymers B in the interior layers 290, 292 are independently chosen from copolyester ether elastomers, copolymers of ethylene acrylates and methacrylates, ethylene methyl-acrylates, ethylene ethyl-acrylates, ethylene butyl acrylates, maleic anhydride modified polyolefin copolymers, methacrylic acid modified polyolefin copolymers, ethylene vinyl alcohol (EVA) polymers, styrenic block copolymers, ethylene propylene copolymers, and thermoplastic polyurethanes (TPU).

In some embodiments, the thermoplastic polymers B are chosen from copolyester ether elastomers, which may be linear, branched, or cyclic. Suitable examples include materials available under the trade designation NEOSTAR such as, for example, FN007, and ECDEL from Eastman Chemical, ARNITEL co-polyester elastomer from DSM Engineering Materials (Troy, MI), RITEFLEX polyester elastomer from Celanese Corporation (Irvine TX), HYTREL polyester elastomer from DowDuPont, copolymers of ethylene and methyl acrylate available from DowDuPont, Midland, MI under the trade designation ELVALOY, ethylene vinyl alcohol (EVA) polymers, and the like.

In presently preferred implementations of multilayer films including the polyester blends of the present disclosure, a layer B including the blend has at least 50% weight of the second, elastomeric polyester based on the total weight of the blend.

In various embodiments, suitable polymers B for the interior layers 290, 292 of the polymeric shell 202 have a flexural modulus less than about 1.10 GPa, less than about 0.24 GPa, or less than about 0.12 GPa.

In one embodiment, one or more layers of a TPU described in International Publication WO2020/225651, which is copending with the present application, and incorporated by reference herein in its entirety, can be used in the multilayered dental appliances described above as the thermoplastic polymer B. This TPU includes monomeric units derived from a polyisocyanate, at least one dimer fatty diol, and an optional hydroxyl-functional chain extender. In some embodiments, the TPU polymer includes hard microdomains formed by reaction between the polyisocyanate and the optional chain extender, as well as soft microdomains formed by reactions between the polyisocyanate and the dimer fatty diol. The dimer fatty diols used to form the TPU are derived from dimer fatty acids, which are dimerization products of mono or polyunsaturated fatty acids and/or esters thereof. The related term trimer fatty acid similarly refers to trimerization products of mono- or polyunsaturated fatty acids and/or esters thereof.

Referring again to FIG. 2, the polymeric shell 202 further includes additional optional performance enhancing layers that can be included to improve properties of the shell 202. In various embodiments, which are not intended to be limiting, the performance enhancing layers can be, for example, barrier layers that are resistant to staining and moisture absorption; abrasion-resistant layers; cosmetic layers that may optionally include a colorant, or may include a polymeric material selected to adjust the optical haze or visible light transparency of the polymeric shell 202; tie layers that enhance compatibility or adhesion between layers AB or BC, elastic layers to provide a softer mouth feel for the patient; thermal forming assistant layers to enhance thermoforming, layers to enhance mold release during thermoforming, and the like.

The performance enhancing layers may include a wide variety of polymers selected to provide a particular performance benefit, but the polymers in the performance enhancing layers are generally selected from materials that are softer and more elastic than the polymers ABC. In various embodiments, which are not intended to be limiting, the performance enhancing layers include thermoplastic polyurethanes (TPU) and olefins.

In some non-limiting examples, the olefins in the performance enhancing layers are chosen from polyethylene (PE), polypropylene (PP), polymethylpentene (PMP), cyclic olefins (COP), copolyolefins with moieties chosen from ethylene, propylene, butene, pentene, hexene, octene, C2-C20 hydrocarbon monomers with polymerizable double bonds, and mixtures and combinations thereof; and olefin hybrids chosen from olefin/anhydride, olefin/acid, olefin/styrene, olefin/acrylate, and mixtures and combinations thereof.

For example, in the embodiment of FIG. 2, the polymeric shell 202 includes an optional moisture barrier layer 240 on each external surface, which can prevent moisture intrusion into the underlying polymeric layers and maintain for the shell 202 a substantially constant stress profile during a treatment time. The polymeric shell 202 further includes tie or thermoforming assist layers 250, which can be the same or different, between individual layers AB or BC. In some embodiments, the tie/thermoforming assist layers 250 can improve compatibility between the polymers in the layers AB or BC as the polymeric shell 202 is formed from a multilayered polymeric film, or reduce delamination between layers AB or BC and improve the durability and crack resistance of the polymeric shell 202 over an extended treatment time. The polymeric shell 202 in FIG. 2 further includes elastic layers 260, which can be the same or different, and can be included to improve the softness or mouth feel of the shell 202. In the embodiment of FIG. 2, the elastic layers 260 are located proximal the major surfaces 220, 222 of the shell 202.

Referring again to FIG. 1, in some embodiments, the polymeric shell 102 is formed from substantially transparent polymeric materials. In this application the term substantially transparent refers to materials that pass light in the wavelength region sensitive to the human eye (about 400 nm to about 750 nm) while rejecting light in other regions of the electromagnetic spectrum. In some embodiments, the reflective edge of the polymeric materials selected for the shell 102 should be above about 750 nm, just out of the sensitivity of the human eye.

In some embodiments, any or all of the layers of the polymeric shell 102 can optionally include dyes or pigments to provide a desired color that may be, for example, decorative or selected to improve the appearance of the teeth of the patient.

The orthodontic appliance 100 may be made using a wide variety of techniques. In one embodiment, a suitable configuration of tooth (or teeth)-retaining cavities are formed in a substantially flat sheet of a multilayered polymeric film that includes layers of polymeric material arranged like the configurations discussed described above with respect to FIGS. 1-2. In some embodiments, the multilayered polymeric film may be formed in a dispersion and cast into a film or applied on a mold with tooth-receiving cavities. In some embodiments, the multilayered polymeric film may be prepared by extrusion of multiple polymeric layer materials through an appropriate die to form the film. In some embodiments, a reactive extrusion process may be used in which one or more polymeric reaction products are loaded into the extruder to form one or more layers during the extrusion procedure.

In some embodiments, the multilayer polymeric film may later be thermoformed into a dental appliance with tooth-retaining cavities or injected into a mold including tooth-retaining cavities. The tooth-retaining cavities may be formed by any suitable technique, including thermoforming, laser processing, chemical or physical etching, and combinations thereof, but thermoforming has been found to provide good results and excellent efficiency. In some embodiments, the multilayered polymeric film is heated prior to forming the tooth-retaining cavities, or a surface thereof may optionally be chemically treated such as, for example, by etching, or mechanically embossed by contacting the surface with a tool, prior to or after forming the cavities.

A general process for thermoforming an appliance using the polyester blend containing films of the present disclosure can share similarities with common thermoforming techniques. One, some, or all of the steps of method may be performed in a temperature and pressure controlled chamber. At the outset, a physical, dental model of the patient's teeth in a target or current arrangement is provided. A sheet of material including at least one layer comprised of a semi-crystalline polymer is provided and placed over the dental model. The model and the sheet of material are placed under a first pressure and heated to a first temperature near, but preferably below, the upper bound of the first identifiable melt temperature range (Tₘ₁) of the semi-crystalline polymer. In particularly suitable methods, the model and the sheet of material are placed under a first pressure and heated to a first temperature near, but preferably below, the endothermic peak maxima (P1) of the first identifiable melt temperature range (Tₘ₁). The combination of heat and pressure/or vacuum causes the material to soften. The model and sheet are maintained at the first temperature and pressure until such time as the sheet has conformed to the shape and orientation of the dental model and some of the crystalline structures in the polymer have melted. The temperature is subsequently decreased (preferably isobarically) to create a shell appliance in a configuration having a geometry corresponding to the dental arrangement of the first model.

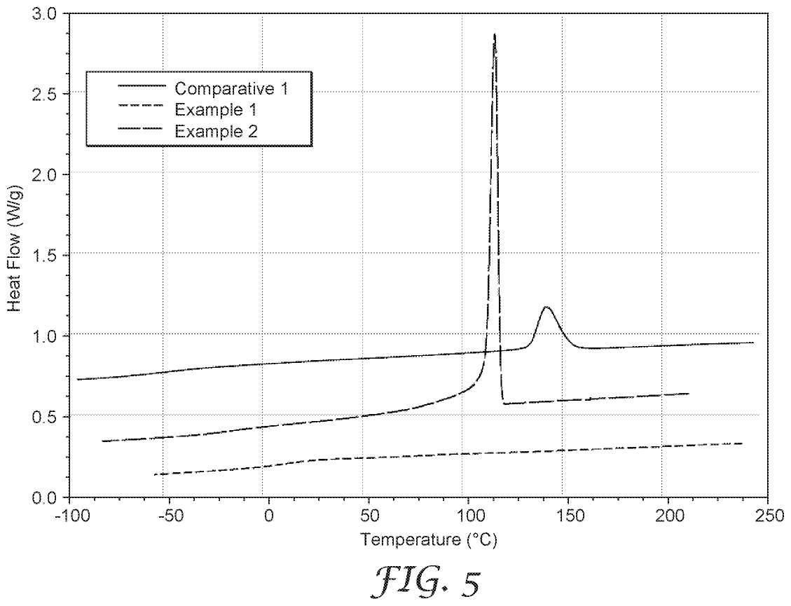

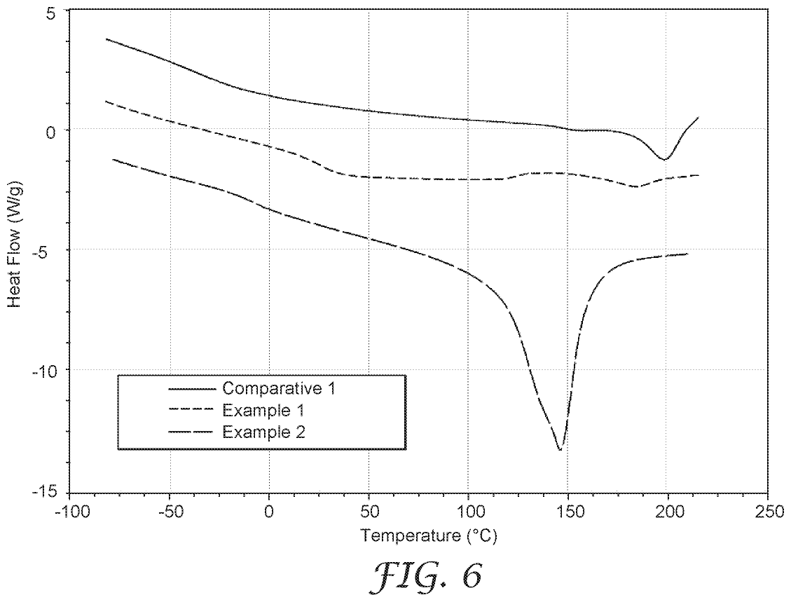

In some embodiments, the polymeric film is heated to a temperature above the Tg, for example, above 120° C., about 130° C., about 140° C., during the forming process. Typically, the first temperature is at least about 5° C. below the upper bound of a first identifiable melting temperature range (Tₘ₁) of at least one of the one or more polymers present in the film (e.g., about 200° C. to about 220° C.) (see e.g., the DSC curves of FIGS. 5 and 6). However, various temperatures and times may be utilized. In other embodiments, the molding temperature is at least about 6° C. below the first identifiable melting temperature (Tₘ₁) of at least one of the one or more polymers present in the film, in some embodiments at least 7° C., at least 8° C., at least 9° C., at least 10° C., at least 11° C., at least 12° C. The likelihood of melting but allowing heterogeneous nucleation upon cooling is enhanced by the addition of a nucleating agent to the one or more semi-crystalline polymer layers, as noted above.

Heating to a temperature near the first melting peak but above the glass transition of the film can typically allow for at least 80%, at least 81%, at least 82%, at least 83%, at least 84%, and least 85%, at least 86%, at least 87%, at least 88%, at least 89%, at least 90% of the crystals present in one or more semi-crystalline elastomers to be melted as the molding temperature nears the upper bound of the first identifiable melt temperature (Tₘ₁) and or the endothermic peak maximum (P1). The degree of melt can be determined by a melt fraction ratio for each example. Keeping the molding temperature below the upper bound if not the endothermic peak maximum, however, allows at least some of the crystalline structures or nucleating sites to remain in the film prior to cooling.

In some embodiments, the pressure applied is greater than 10 kPa, e.g., greater than 50 kPa, 75 kPa, 100 kPa, 125 kPa, or greater than 150 kPa. In some embodiments, the pressure is maintained for greater than 30 seconds, e.g., greater than 45 seconds, 60 seconds, 2.5 minutes, 5.0 minutes, 10 minutes, 20 minutes, 30 minutes, 60 minutes, greater than 90 minutes, or even greater than 120 minutes, before release of pressure back to nominal atmospheric pressure. The pressure may be applied by direct force on the polymeric film material and/or vacuum.

A first plurality of crystalline structures is formed in any semi-crystalline polymeric material as the temperature is reduced from first molding temperature to a subsequent temperature (e.g., room temperature). The crystalline structures formed help hold the appliance in a stored geometry prior to irradiation or other suitable method of creating crosslinks in the polymeric material and are preferably sufficiently small so as not to contribute to a hazy appearance. In some or all embodiments, the temperature is gradually reduced. In other embodiments, appliance may be quenched by rapid reduction in temperature. In any event, it is presently preferred that the parameters selected remain consistent for each appliance. For example, the rate of temperature reduction could be in the range of about 0.5° C. to about 10° C. per minute, but is typically held at the same rate within the range for each temperature reduction step in the process.

The multilayered polymeric film, the formed dental appliance, or both, may optionally be crosslinked with radiation chosen from ebeam, gamma, UV, and mixtures and combinations thereof.

Irradiation, if used to crosslink the material, can be done at room temperature or at elevated temperatures typically below the first molding temperature. Irradiation can be performed in air, in vacuum, or in oxygen-free environment, including inert gases such as nitrogen or noble gases. Irradiation can be performed by using electron-beam, gamma irradiation, or x-ray irradiation. In some embodiments, an ionizing radiation (e.g., an electron beam, x-ray radiation or gamma radiation) is employed to crosslink the non-segmented, polymeric material. In specific embodiments, gamma radiation is employed to crosslink the substantially non-crosslinked polymeric material. In some embodiments, the irradiating (with any radiation source) is performed until the sample receives a dose of at least 0.25 Mrad (2.5 kGy), e.g., at least 1.0 Mrad (10 kGy), at least 2.5 Mrad (25 kGy), at least 5.0 Mrad (50 kGy), or at least 10.0 Mrad (100 kGy). In some embodiments, the irradiating is performed until the sample receives a dose of between 1.0 Mrad and 6.0 Mrad, e.g., between 1.5 Mrad and 4.0 Mrad.

In other embodiments, the appliance is treated to create chemical crosslinks using methods known in the art. For example, peroxides can be added to the polymer, and the polymer can be maintained at an elevated temperature after forming into the first stored geometry to allow the peroxides to react. In addition, silanes can be grafted to a polymer backbone, such as polyethylene, and the polymer can be crosslinked upon exposure to a hot, humid environment.

The thickness of the multilayer polymer film is chosen to provide a clinically appropriate thickness of the material in the resultant appliance. The thickness of the material should typically be selected such that the appliance is stiff enough to apply sufficient force to the teeth but remains thin enough to be comfortably worn. In various embodiments, the multilayered polymeric film used to form the dental appliance has a thickness of less than about 1 mm, or less than about 0.8 mm, or less than about 0.5 mm. The thickness of the walls of the resulting appliance may be between 0.05 mm and 2 mm, or between 0.1 mm and 1 mm.

In various embodiments, particularly those including polyester blends of the present disclosure, the dental appliance is substantially optically clear. The Expected light transmission can be determined by ISO 13468-1:2019 or ASTM D1003-13 using CIE illuminate C and the Expected haze can be determined using ISO 14782-1:1999 or ASTM D1003-13 using CIE illuminate C. The term “Expected” is used herein to indirectly represent the transmission and haze of a formed appliance, as the geometry (e.g., size and surface features) of the appliance is not conducive to direct testing. Instead, a representative polymeric film is subjected to the same temperature and processing conditions as would normally be used to create the appliance but without drawing the film down on a mold, allowing the film to remain sufficiently planar for subsequent testing.

Some embodiments have an Expected light transmission of at least about 50%. Some embodiments have an expected light transmission of at least about 75%. Some embodiments have an Expected haze of no greater than 15 or no greater than 10%. Some embodiments have an Expected haze of no greater than 5%. Some embodiments have an Expected haze of no greater than 2.5%. The Expected haze of dental appliance of certain presently preferred embodiments is less than 10% and the Expected light transmission of dental appliance is greater than 80%.

In some embodiments, the multilayered polymeric film may be manufactured in a roll-to-roll manufacturing process and may optionally be wound into a roll until further converting operations are required to form one or more dental appliances.

The orthodontic article 100 can exhibit a percent loss of relaxation modulus of 40% or less as determined by Dynamic Mechanical Analysis (DMA). The DMA procedure is described in detail in the Examples below. The loss is determined by comparing the initial relaxation modulus to the (e.g., 4 hour) relaxation modulus at 37° C. and 1% strain. It was discovered that orthodontic articles according to at least certain embodiments of the present disclosure exhibit a smaller loss in relaxation modulus than articles made of different materials. Preferably, an orthodontic article exhibits loss of relaxation modulus after hydration of 40% or less, 38% or less, 36% or less, 34% or even 32% or less. In some embodiments, the loss of relaxation modulus is at least 15%, 20%, or 25% or greater.

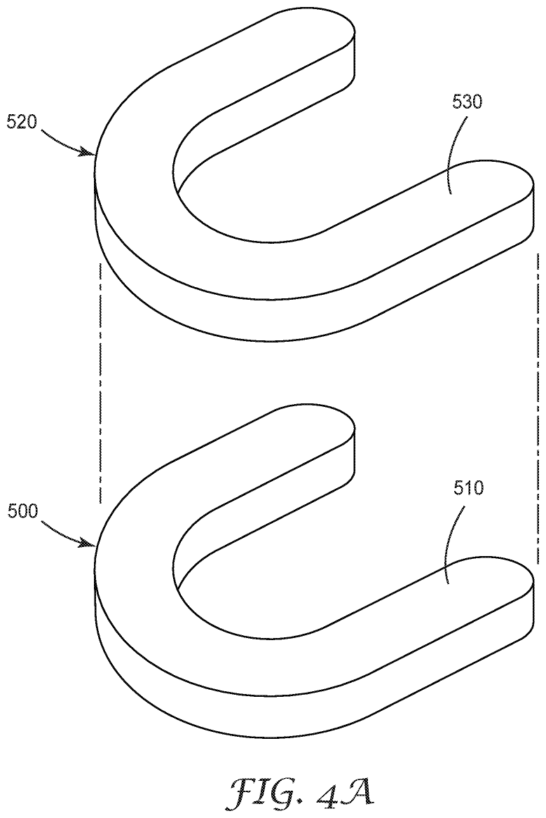

Referring now to FIG. 3, a shell 402 of an orthodontic appliance 400 includes an outer surface 406 and an inner surface 408 with cavities 404 that generally conform to one or more of a patient's teeth 600. In some embodiments, the cavities 404 are slightly out of alignment with the patient's initial tooth configuration, and in other embodiments the cavities 404 conform to the teeth of the patient to maintain a desired tooth configuration. In some embodiments, the shell 402 may be one of a group or a series of shells having substantially the same shape or mold, or incrementally different shapes, but which are formed from different polymeric materials, or different layers of polymeric materials, selected to provide a desired stiffness or resilience as needed to move the teeth of the patient. In some embodiments, the shell 402 may be one of a group or a series of shells having substantially the same shape or mold, or incrementally different shapes, but which are formed from the same polymeric materials, selected to provide a desired stiffness or resilience as needed to move the teeth of the patient. In this manner, in one embodiment, a patient or a user may alternately use one of the orthodontic appliances during each treatment stage depending upon the patient's preferred usage time or desired treatment time period for each treatment stage.

No wires or other means may be provided for holding the shell 402 over the teeth 600, but in some embodiments, it may be desirable or necessary to provide individual anchors on teeth with corresponding receptacles or apertures in the shell 402 so that the shell 402 can apply a retentive or other directional orthodontic force on the tooth which would not be possible in the absence of such an anchor.

The shells 402 may be customized, for example, for day time use and night time use, during function or non-function (chewing vs. non-chewing), during social settings (where appearance may be more important) and nonsocial settings (where the aesthetic appearance may not be a significant factor), or based on the patient's desire to accelerate the teeth movement (by optionally using the more stiff appliance for a longer period of time as opposed to the less stiff appliance for each treatment stage).

For example, in one aspect, the patient may be provided with a clear orthodontic appliance that may be primarily used to retain the position of the teeth, and an opaque orthodontic appliance that may be primarily used to move the teeth for each treatment stage. Accordingly, during the daytime, in social settings, or otherwise in an environment where the patient is more acutely aware of the physical appearance, the patient may use the clear appliance. Moreover, during the evening or nighttime, in non-social settings, or otherwise when in an environment where physical appearance is less important, the patient may use the opaque appliance that is configured to apply a different amount of force or otherwise has a stiffer configuration to accelerate the teeth movement during each treatment stage. This approach may be repeated so that each of the pair of appliances are alternately used during each treatment stage.

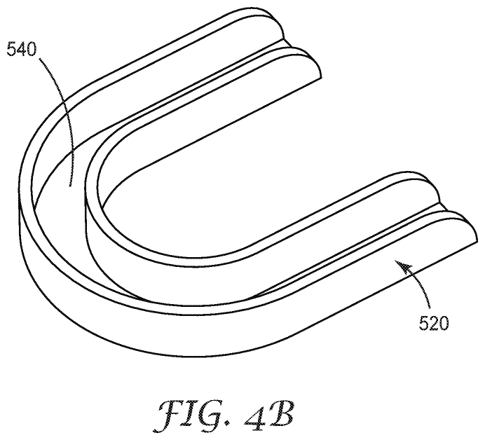

Referring again to FIG. 4, an orthodontic treatment system and method of orthodontic treatment includes applying to the teeth of a patient one or more incremental position adjustment appliances, each having substantially the same shape or mold, or incrementally different shapes. The incremental adjustment appliances may each be formed from the same or a different combination of polymeric materials, as needed for each treatment stage of orthodontic treatment. The orthodontic appliances may be configured to incrementally reposition individual or multiple teeth 600 in an upper or lower jaw 602 of a patient. In some embodiments, the cavities 404 are configured such that selected teeth will be repositioned, while other teeth will be designated as a base or anchor region for holding the repositioning appliance in place as the appliance applies the resilient repositioning force against the tooth or teeth intended to be repositioned.

Placement of the elastic positioner 400 over the teeth 600 applies controlled forces in specific locations to gradually move the teeth into the new configuration. Repetition of this process with successive appliances having different configurations eventually moves the teeth of a patient through a series of intermediate configurations to a final desired configuration.

The devices of the present disclosure will now be further described in the following non-limiting examples.

### EXAMPLES

The following Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, and the like in the Examples and the rest of the specification are provided on the basis of weight. Solvents and other reagents used may be obtained from Sigma-Aldrich Chemical Company (Milwaukee, WI) unless otherwise noted.

### Materials

MX710: copolyester (PCTT) from Eastman Chemicals, brand: TRITAN
FN007: copolyester ether elastomer (PCCE) from Eastman Chemicals, brand: NEOSTAR
9967: copolyester ether elastomer (PTME modified PCCE) from Eastman Chemicals, brand: ECDEL
SR549M: Polypropylene from LyondellBasell, brand: PROFAX
Blend 1: a polyester blend including 70% weight FN007 and 30% weight MX710
Blend 2: a polyester blend including 50% weight FN007 and 50% weight MX710
Blend 3: a polyester blend including 60% weight 9967 and 40% weight MX710

### Properties of Selected Materials

Properties of some of the polymeric materials used in the examples below are shown in Table 1 below.

TABLE 1
Properties of select polyesters for Blends

| | | | | Vicat | | | | Solubility | Inherent | 2,2,4,4- |
|---|---|---|---|---|---|---|---|---|---|---|
| | | | | Softening | Flexural | | Elongation | Parameter | Viscosity | Tetramethyl-1,3- |
| | Tg* | | Tm* | Temp.* | Modulus* | | at Break* | (cal^{1/2} cm^{-3/2}) | (cc/gm)* | cyclobutanediol |
| MX710 | 110° | C. | N/A | 110° C. | 1.55 | GPa | 210% | 9 | 0.724 | 25% |
| FN007 | <0° | C. | 205° C. | 170° C. | 0.2 | GPa | 400% | 8.9 | 1.2 | N/A |
| 9967 | <0° | C. | 205° C. | 170° C. | 0.2 | GPa | 400% | 8.9 | 1.2 | N/A |

*as reported by supplier of the material

### Summary of Test Procedures

The following test procedures were used in the examples below.

### Flexural Modulus and Elongation at Break

The flexural modulus was tested according to ASTM D790-17 and tensile properties by ASTM D638-14. The specimen made by die cutting was placed in the grips of a universal testing machine. The stress-strain curve was then utilized to determine the modulus and elongation at break.

### Stress Relaxation by Dynamic Mechanical Analyzer (DMA)

DMA 3-point bend rectangular specimens can be tested in a TA Instruments Q800 DMA (New Castle, DE). Samples are preconditioned in water for 24 hours prior to testing. The preconditioned samples are then tested by single cantilever bending in a DMA machine enclosed with an environmental chamber kept at 37° C. and 95% relative humidity. Stress relaxation is monitored after applying 1% strain and strain recovery is measured after the stress is removed. The testing time is about 4 hours. The stress relaxation is determined by comparing the initial relaxation modulus to the 4 hour relaxation modulus at 37° C. and 2% strain. Force persistence can be defined, then, as 100% minus the % stress relaxation (e.g., a stress relaxation of 25% equates to a force persistence of 75%).

### Melting Temperature and Glass Transition Temperature

The melting and crystallization feature temperatures and the glass transition temperature for the resins and blends were examined utilizing Differential Scanning calorimetry (DSC), unless reported by manufacturer of the material. The specimens for DSC analysis were prepared by weighing and loading 3-5 mg of the material into TA Instruments Tzero hermetic aluminum DSC sample pans with a pinhole in the lid.

The resin and blend specimens were analyzed using a TA Instruments Discovery 2500 Differential Scanning calorimeter (DSC2A-00886/LN2) system in Standard DSC mode utilizing a multiple rate and heat-cool cycle procedure. This cycle was repeated to capture data cooling at rates of 80-60-40-20-10-5° C./min. The method repeatedly equilibrated the sample at 250° C., held it for 5 min. and cooled the sample at the rates noted; capturing the heating cycle data as the sample was readied to evaluate the next cooling rate.

After data collection, the thermal transitions were analyzed using the TA Universal Analysis program. If present, any glass transitions (Tg) or significant endothermic or exothermic peaks were evaluated. The glass transition temperatures were evaluated using the step change in the standard heat flow (HF) curves.

### Haze and Transmission

Haze and transmission, as well as Expected haze and Expected transmission, were determined using a HAZE-GARD PLUS meter available from BYK-Gardner Inc., Silver Springs, MD, which was designed to comply with the ASTM D1003-13 standard. The specimen surface is illuminated perpendicularly with the transmitted light, measured with an integrating sphere (0°/diffuse geometry). The spectral sensitivity conforms to CIE standard spectral value function “Y” under illuminant C with a 2° observer.

### Procedure for Thermoforming and Temperature Measurement

A BIOSTAR VI pressure molding machine (Scheu-Dental GmbH, Iserlohn, Germany) is used to form the film into an article. To thermoform, a 125 mm diameter piece of film was heated for a specific time and then pulled down over a rigid-polymer model. The model 500 includes one or more flat occlusal surfaces 510 that result in similar flat occlusal surfaces (530, 540) of the thermoformed tray 520 to permit direct measurement of Haze (as seen FIG. 4A). Maximum temperature of the film was measured using an IR thermometer (FLIR TG165) before pulling down over the rigid-polymer model. The BIOSTAR chamber behind the film was pressurized to 90 psi for 15 seconds of cooling time, after which the chamber was vented to ambient pressure and the formed article and arch model were removed from the instrument and cooled down to room temperature under ambient condition. For Expected haze and transmission measurements, the sample film is not drawn over the model but otherwise subject to the same temperature and pressure increase as if the film was thermoformed into an article.

### Comparative Example 1

A 3-layer ABA (SR549M/FN007/SR549M) film was extruded using a pilot scale coextrusion line equipped with a feedblock and film die. The resins were not predried prior to extrusion for the extruders are equipped with vacuum port near the end of the extruder for removing volatiles. The skin layer (A) extruder was fed with polypropylene. The skin layer (A) extrusion melt temperature was controlled at 530F. The throughput was 8 lbs/hr. The core layer (B) extruder was fed with NEOSTAR FN007 and the extrusion melt temperature was controlled at 520F. The core layer extrusion throughput was 6 lbs/hr. The extruded sheet was chilled on a cast roll. The thickness of core layer for Example 1 was controlled at 14 mils.

### Example 1

A 3-layer ABA (SR549M/BLEND 1]/SR549M) film was extruded using a pilot scale coextrusion line equipped with a feedblock and film die. The resins were not predried prior to extrusion for the extruders are equipped with vacuum port near the end of the extruder for removing volatiles. The skin layer (A) extruder was fed with polypropylene. The skin layer (A) extrusion melt temperature was controlled at 530F. The throughput was 8 lbs/hr. The core layer (B) extruder was fed with Blend 1 (70/30 of NEOSTAR FN007/TRITAN) and the extrusion melt temperature was controlled at 520F. The core layer extrusion throughput was 6 lbs/hr. The extruded sheet was chilled on a cast roll. The thickness of core layer for Example 1 was controlled at 14 mils.

### Example 2

A 3-layer ABA (SR549M/BLEND 2/SR549M) film was extruded using a pilot scale coextrusion line equipped with a feedblock and film die. The resins were not predried prior to extrusion for the extruders are equipped with vacuum port near the end of the extruder for removing volatiles. The skin layer (A) extruder was fed with polypropylene. The skin layer (A) extrusion melt temperature was controlled at 530F. The throughput was 8 lbs/hr. The core layer (B) extruder was fed with 50/50 of NEOSTAR FN007/TRITAN and the extrusion melt temperature was controlled at 520F. The core layer extrusion throughput was 6 lbs/hr. The extruded sheet was chilled on a cast roll. The thickness of core layer for Example 3 was controlled at 14 mils.

### Comparative Example 2

A 3-layer ABA (SR549M/BLEND 2/SR549M) film was extruded using a pilot scale coextrusion line equipped with a feedblock and film die. The resins were not predried prior to extrusion for the extruders are equipped with vacuum port near the end of the extruder for removing volatiles. The skin layer (A) extruder was fed with polypropylene. The skin layer (A) extrusion melt temperature was controlled at 530F. The throughput was 15.8 lbs/hr. The core layer (B) extruder was fed with 70/30 of NEOSTAR FN007/TRITAN and the extrusion melt temperature was controlled at 520F. The core layer extrusion throughput was 12 lbs/hr. The extruded sheet was chilled on a cast roll. The thickness of core layer for Comparative Example 1 was controlled at 14 mils.

After removing polypropylene skins, the core layers from Examples 1-2 and Comparative Examples 1 and 2 were characterized for Haze and tensile properties. Testing results are presented in Table 2, below. DSC cooling and heating curves for the core layer materials from Examples 1-2 and Comparative Example 1 are displayed in FIGS. 5 & 6. There is only one Tg (glass transition temperature) and one Tm (melting point) or Tc (crystallization temperature) observed from the samples of Examples 1 & 2 from the heating and cooling analysis supporting that the samples of Examples 1 & 2 are miscible blends. Similar curves were observed when the samples were examined according to the procedures described above after all cooling rates (80-60-40-20-10-5° C./min), demonstrating that the samples of Examples 1 & 2 are indeed miscible blends. Example 2 and Comparative Example 2 have the same core layer composition. However, Comparative Example 2 has a much higher haze due to the shorter residence time of the melt stream through extruder B.

TABLE 2
Core layer tensile properties and haze for
Examples 1-2 and Comparative Example 1-2

| | Tensile | | |
|---|---|---|---|
| | Modulus | Strain | |
| | (GPa) | Yield (%) | Haze (%) |
| Comparative Example 1 | 0.19 | 16.6 | 5.1 |
| Example 1 | 0.51 | 12.1 | 3.29 |
| Example 2 | 1.03 | 4 | 2.7 |
| Comparative Example 2 | N/A | N/A | 18.4 |

Example 3 A 3-layer ABA (MX710/BLEND 1/MX710) film was extruded using a pilot scale coextrusion line equipped with a feedblock and film die. The resins were not predried prior to extrusion for the extruders are equipped with vacuum port near the end of the extruder for removing volatiles. The skin layer (A) extruder was fed with the first rigid resin, MX710. The skin layer (A) extrusion melt temperature was controlled at 560F. The throughput was 12 lbs/hr. The core layer (B) extruder was fed with BLEND 1 and the extrusion melt temperature was controlled at 490F. The core layer extrusion throughput was 6 lbs/hr. The extruded sheet was chilled on a cast roll. The overall sheet thickness was controlled at 30 mils and the haze of the film was determined about 1.1%.

### Comparative Example 3

A 5-layer ABCBA (MX710/FN007/MX710/FN007/MX710) film was extruded using a pilot scale coextrusion line equipped with a feedblock and film die. The skin layer (A) extruder was fed with the first rigid resin, MX710. The skin layer (A) extrusion melt temperature was controlled at 505F. The throughput was 4.3 lbs/hr. The core layer (C) extruder was also fed with the first rigid resin, MX710, and the extrusion melt temperature was controlled at 550F. The core layer extrusion throughput was 11.6 lbs/hr. The middle layer (B) extruder was fed with a second thermoplastic elastomeric resin, FN007, and the extrusion temperature was controlled at 470F. The middle layer extrusion throughput was 5.54 lbs/hr. The extruded sheet was chilled on a cast roll. The overall sheet thickness was controlled at 30 mils and the haze of the film was determined 2.6%.

### Example 4

The sample from Example 3 was sandwiched between two glass slides and placed in an oven at 210 C for 10 minutes. The sample was then removed from the oven and cooled to room temperature under ambient environment. Haze of the sandwiched sample was measured and is 4.95%.

### Example 5

The sample from Example 3 was sandwiched between two glass slides and placed in an oven at 220 C for 10 minutes. The sample was then removed from the oven and cooled to room temperature under ambient environment. Haze of the sandwiched sample was measured and is 4.69%.

### Example 6

The sample from Example 3 was sandwiched between two glass slides and placed in an oven at 230 C for 10 minutes. The sample was then removed from the oven and cooled to room temperature under ambient environment. Haze of the sandwiched sample was measured and is 4.95%.

### Comparative Example 4

The sample from Comparative Example 3 was sandwiched between two glass slides and placed in an oven at 210 C for 10 minutes. The sample was then removed from the oven and cooled to room temperature under ambient environment. Haze of the sandwiched sample was measured and is 3.29%.

### Comparative Example 5

The sample from Comparative Example 3 was sandwiched between two glass slides and placed in an oven at 220 C for 10 minutes. The sample was then removed from the oven and cooled to room temperature under ambient environment. Haze of the sandwiched sample was measured and is 42.3%.

### Comparative Example 6

The sample from Comparative Example 2 was sandwiched between two glass slides and placed in an oven at 230 C for 10 minutes. The sample was then removed from the oven and cooled to room temperature under ambient environment. Haze of the sandwiched sample was measured and is 45.8%.

TABLE 3
Haze vs Heat Treatment Temperature for Examples
4-6 and Comparative Examples 4-6

| Heat | |
|---|---|
| treatment | |
| temperature | Haze (%) |

| | (° C.) | average | std |
|---|---|---|---|
| Example 4 | 210 | 4.95 | 0.99 |
| Example 5 | 220 | 4.69 | 0.27 |
| Example 6 | 230 | 4.95 | 0.99 |
| Comparative 4 | 210 | 3.29 | 0.10 |
| Comparative | 220 | 42.30 | 2.56 |
| Example 5 | | | |
| Comparative | 230 | 45.80 | 2.19 |
| Example 6 | | | |

### Example 7-9 and Comparative Example 7

Several films of BLEND 3 were extruded using a pilot scale coextrusion line equipped with a feedblock and film die. The resins were not predried prior to extrusion for the extruders are equipped with vacuum port near the end of the extruder for removing volatiles. The extrusion melt temperature was controlled at 490° F. The extrusion throughput was varied to examine the effective of residence time in the extruder on the Haze of the resulting film. Haze of sample films were measured and the results are reported in Table 4 below.

The haze level was found higher (>20% haze) than desired if the residence time was shorter than 7 minutes.

TABLE 4
Haze vs extrusion residence time

| | |
|---|---|
| Residence | |
| Time | Haze (%) |

| | (minutes) | average | std |
|---|---|---|---|
| Comparative | 6.8 | 20.1 | 2.0 |
| Example 7 | | | |
| Example 7 | 8.0 | 6.5 | 1.2 |
| Example 8 | 10.0 | 1.5 | 0.2 |
| Example 9 | 13.0 | 1.5 | 0.1 |

### Examples 10-13 and Comparative Examples 8-11

Various blends of 9967 and MX710 were extruded with the 13-minute residence time. The films had a thickness of 12.5 mils. Each of the film formed from the Exemplary blends, along with films form from exclusively 9967 or MX710, were tested for Haze and the results reported in Table 5 below.

TABLE 5
Haze of the films made from the blends of 9967 with MX710

| ECDEL | TRITAN | |
|---|---|---|
| 9967 | MX710 | Haze (%) |

| | (%) | (%) | average | std |
|---|---|---|---|---|
| Comparative Ex. 8 | 100 | 0 | 13.9 | 0.7 |
| Example 10 | 80 | 20 | 5.0 | 0.8 |
| Example 11 | 50 | 50 | 1.2 | 0.2 |
| Example 12 | 45 | 55 | 4.1 | 0.6 |
| Example 13 | 40 | 60 | 14.3 | 1.6 |
| Comparative Ex. 9 | 20 | 80 | 25.5 | 0.8 |
| Comparative Ex. 10 | 10 | 90 | 20.7 | 0.8 |
| Comparative Ex. 11 | 0 | 100 | 1.5 | 0.2 |

### Example 14-18

Films incorporating various polyester blends were made with the same process conditions in Examples 10-13 above except to reduce the line speed by half to double their thickness. Their Haze is reported in Table 5 below.

TABLE 5
Haze of the films in Examples 14-17

Haze (%)

| | average | std |
|---|---|---|
| Example 14 (20% MX710 + 80% 9967) | 17.7 | 1.0 |
| Example 15 (40% MX710 + 60% ECDEL | 2.7 | 0.4 |
| 9967) | | |
| Example 16 (50% MX710 + 50% 9967) | 2.7 | 0.1 |
| Example 17 (55% MX710 + 45% 9967) | 15.6 | 1.3 |

### Examples 18-21

The films of Examples 14-17 were subsequently thermoformed into an orthodontic aligner tray 520, as depicted in FIGS. 4A & 4B. The haze of the thermoformed trays was then measured from the flat, outer occlusal surface 530 and the results are displayed in Table 6.

TABLE 6
Haze of Examples 18-21 thermoformed trays
made with the films from Examples 14-17

| | | Haze (%) of | |
|---|---|---|---|
| | | Thermoformed Tray | |
| | Input Film | average | std |
| Example 18 | Example 14 (20% MX710 + | 14.9 | 0.6 |
| | 80% 9967) | | |
| Example 19 | Example 15 (40% MX710 + | 6.8 | 1.17 |
| | 60% ECDEL 9967) | | |
| Example 20 | Example 16 (50% MX710 + | 3.1 | 0.47 |
| | 50% 9967) | | |
| Example 21 | Example 17 (55% MX710 + | 13.6 | 0.56 |
| | 45% 9967) | | |

The patents, patent documents, and patent applications cited herein are incorporated by reference in their entirety as if each were individually incorporated by reference. Although specific embodiments of the present disclosure have been shown and described herein, it is understood that these embodiments are merely illustrative of the many possible specific arrangements that can be devised in application of the principles of the present disclosure. Numerous and varied other arrangements can be devised in accordance with these principles by those of ordinary skill in the art without departing from the spirit and scope of the present disclosure. Thus, the scope of the present disclosure should not be limited to the structures described in this application, but only by the structures described by the language of the claims and the equivalents of those structures.

1. A dental appliance comprising
A polymeric shell comprising a plurality of cavities for receiving one or more teeth, wherein the polymeric shell comprises at least one layer including a polyester blend, the blend comprising:
(a) a first, amorphous polyester; and
(b) a second, semi-crystalline polyester elastomer, wherein the polyester blend does not include a substantial amount of plasticizer, and wherein the shell has an Expected haze of no greater than 20%, determined using ASTM D1003-13.

2. The dental appliance of the claim 1, wherein the blend is miscible, in that is exhibits a single glass transition temperature under DSC, in the absence of a compatibilizer.

3. The dental appliance of claim 1, wherein the shell includes a multilayer film including a core layer, a skin layer, and at least one inner layer disposed between the core and skin, and wherein the inner layer includes the miscible polyester blend.

4. The dental appliance of claim 1, wherein the appliance exhibits a Force Persistence of at least 50%

5. The dental appliance of claim 1, wherein the appliance exhibits a Force Persistence of at least 65%.

6. The dental appliance of claim 1, wherein the blend comprises 80 to 40 weight % of the second polyester and 20 to 60 weight % of the first polyester.

7. The dental appliance of claim 6, wherein the first polyester comprises 2,2,4,4-tetramethyl-1,3-cyclobutanediol modified poly(1,4-cyclohexylenedimethylene terephthalate) (PCTT).

8. The dental appliance of claim 6, wherein the second polyester comprises poly(1,4-cyclohexanedimethylene 1,4-cyclohexanedicarboxylate) (PCCE) or PCCE modified with polytertramethylene ether glycol (mPCCE).

9. The dental appliance of claim 8, wherein the blend comprises 60 to 40 weight % of PCCE or mPCCE, and 40 to 60 weight % of PCTT.

10. The dental appliance of claim 1, any one of the previous claims, wherein the appliance has an Expected haze of no greater than 10%.

11. A film comprising
at least one layer including a polyester blend, the blend comprising:
(a) a first, amorphous polyester; and
(b) a second, semi-crystalline polyester elastomer, wherein the polyester blend does not include a substantial amount of plasticizer, and wherein the film has a haze of no greater than 20%.

12. The film of the claim 11, wherein the blend is miscible, in that is exhibits a single glass transition temperature under DSC, in the absence of a compatibilizer.

13. The film of claim 11, wherein the blend comprises 5 to 60 weight % of the first polyester and 95 to 40 weight % of the second polyester elastomer.

14. The film of claim 13, wherein the blend comprises 20 to 60 weight % of the first polyester and 80 to 40 weight % of the second polyester elastomer.

15. The film of claim 13, wherein the first polyester comprises 2,2,4,4-tetramethyl-1,3-cyclobutanediol modified poly(1,4-cyclohexylenedimethylene terephthalate) (PCTT).

16. The film of claim 13, wherein the second polyester comprises poly(1,4-cyclohexanedimethylene 1,4-cyclohexanedicarboxylate) (PCCE) or PCCE modified with polytetramethylene ether glycol (mPCCE).

17. The film of claim 16, wherein the PCCE is mPCCE.

18. The film of claim 16, wherein the blend comprises 80 to 40 weight % of PCCE or mPCCE and 20 to 60 weight % of PCTT.

19. A method of forming a shaped article, the method comprising:
providing a sheet of film comprising at least one layer including a polyester blend comprising:
(a) a first, amorphous polyester; and (b) a second, semi-crystalline polyester elastomer, wherein the polyester blend does not include a plasticizer,
providing a first positive model;
drawing the sheet over the model at a molding temperature; and
cooling the sheet and model to atmospheric temperature to form an article, wherein the formed article has an Expected haze of less than 17%.

20. The method of claim 19, wherein the article is a tray aligner, and wherein the first positive model is representative of a patient's dentition.
